(19) United States
(12) Patent Application Publication
(10) Pub. No.: US 2018/0089094 A1
(43) Pub. Date: Mar. 29, 2018

(54) PRECISE INVALIDATION OF VIRTUALLY TAGGED CACHES

(71) Applicant: QUALCOMM Incorporated, San Diego, CA (US)

(72) Inventors: Robert Douglas CLANCY, Cary, NC (US); Gaurav MEHTA, Oviedo, FL (US); Spencer Ellis WILLIAMS, Raleigh, NC (US); Brian Michael STEMPEL, Raleigh, NC (US); Thomas Philip SPEIER, Wake Forest, NC (US); Michael Scott MCILVAINE, Raleigh, NC (US); William James MCAVOY, Raleigh, NC (US)

(21) Appl. No.: 15/274,644

(22) Filed: Sep. 23, 2016

(51) Int. Cl. G06F 12/0891; G06F 12/0895; G06F 12/1045

(52) U.S. Cl. CPC G06F 12/0891; G06F 12/0895; G06F 2212/683; G06F 2212/152; G06F 2212/608; G06F 12/1063

(57) ABSTRACT

Systems and methods for precise invalidation of cache lines of a virtually indexed virtually tagged (VIVT) cache include associating, with each cache line of the VIVT cache, at least a translation lookaside buffer (TLB) index corresponding to a TLB entry which comprises a virtual address to physical address translation for the cache line. The TLB entries are inclusive of the cache lines of the VIVT cache. Upon receiving an invalidate instruction, the invalidate instruction is filtered at the TLB to determine if the invalidate instruction might affect cache lines in the VIVT cache. If the invalidate instruction might affect cache lines in the VIVT cache, the TLB indices of the TLB entries which match the invalidate instruction are determined, and only the cache lines of the VIVT cache which are associated with the affected TLB indices are selectively invalidated.

### FIELD OF DISCLOSURE

Disclosed aspects are directed to processing systems designed to handle virtual addresses. More specifically, exemplary aspects are directed to precise and efficient invalidation mechanisms for virtually tagged structures such as a virtually indexed virtually tagged (VIVT) cache.

### BACKGROUND

In processing systems, for example, with a shared memory accessible by multiple applications or processors, virtual memory is well known in the art for extending real or physical memory space and improving the efficiency of sharing the physical memory amongst the various applications, processors, etc. A virtual address is used for addressing the virtual memory space which is divided into blocks of contiguous virtual memory addresses, or “pages.” Software programs may be conveniently written with reference to virtual addresses and for execution of program instructions by the processors, a translation of the virtual addresses to physical address may be performed.

Memory management units (MMUs) may be used for looking up page tables which map virtual addresses to corresponding physical addresses in order to obtain translations of the virtual addresses to physical addresses, a process referred to in the art as a “page table walk”. Page table walks may be time consuming and so MMUs may include hardware such as a translation lookaside buffer (TLB) to cache translations for frequently accessed pages. The TLB may be implemented as a tagged hardware lookup table, which is tagged using the virtual addresses. Thus, if a virtual address hits in the TLB (i.e., there is a matching tag in the TLB for the virtual address), the corresponding physical address translation may be retrieved from the TLB, without having to incur the costs associated with a page table walk. The retrieved physical address may then be used for accessing memory structures such as the shared memory or one or more caches which may be present between the processors and the shared memory.

A cache, as known in the art, is designed to be small, high speed memory structures which store a limited number of frequently accessed data (or data determined to have high likelihood of future use) and offer a faster access path for the data stored in the cache, in comparison to the longer access times which may be incurred for accessing a backing storage location of the cache (e.g., another cache or the shared memory such as a main memory). While the cache may be indexed and tagged with physical addresses associated with the data stored therein (also referred to as a physical indexed physically tagged or “PIPT” cache), it may be beneficial to alternatively implement the cache as a memory structure which is indexed and tagged using virtual addresses (also referred to as a virtually indexed and virtually tagged or “VIVT” cache). Since the VIVT cache may be accessed using the virtual addresses, a translation of the virtual addresses to physical addresses is not required to search the cache, and so the VIVT cache may offer a faster access time.

However, in some cases, the VIVT cache may be made to appear as a PIPT cache to software, to avoid scenarios where an entire cache may be invalidated by software upon a translation change (e.g., pursuant to a context switch between applications which use different pages and correspondingly, different virtual to physical address translations) that might not even be relevant to the cache. However, conventional implementations of a VIVT cache which appears as a PIPT cache to software suffers from drawbacks. For example, each virtual address page may cover a physical address space which is greater than the size of a cache line of the cache. Accordingly, even if only a single entry of the TLB or a single page is to be invalidated for a given TLB invalidate operation, there are no efficient processes known in the art for determining which specific cache lines of the cache are to be correspondingly invalidated. Thus, in conventional implementations, in the case of a TLB invalidate operation, the entire VIVT cache is invalidated.

Since TLB invalidates can occur frequently, e.g., in the case of multiprocessor systems with numerous processors or applications which share the same physical memory, there may be frequent invalidations of entire caches. Invalidating an entire cache can have severe performance impacts. For example, if an entire instruction cache is invalidated pursuant to a TLB invalidate, then processors which derive instructions from the instruction cache may stall, leading to undesirable delays and loss of performance.

Accordingly, there is a need in the art for more efficient techniques for handling TLB invalidate operations, for example, with respect to their impact on VIVT caches.

### SUMMARY

Exemplary aspects of the invention are directed to systems and methods for precise invalidation of cache lines of a virtually indexed virtually tagged (VIVT) cache. At least a translation lookaside buffer (TLB) index corresponding to a TLB entry which comprises a virtual address to physical address translation for a cache line is associated with the cache line. The TLB entries are inclusive of the cache lines of the VIVT cache. Upon receiving an invalidate instruction, the invalidate instruction is filtered at the TLB to determine if the invalidate instruction is likely to affect one or more cache lines in the VIVT cache. If the invalidate instruction is likely to affect one or more cache lines in the VIVT cache, the TLB indices of the TLB entries which correspond to the invalidate instruction are determined, and only the cache lines of the VIVT cache which are associated with the affected TLB indices are selectively invalidated.

For example, an exemplary aspect is directed to a method of managing a virtually indexed virtually tagged (VIVT) cache. The method comprising associating, with each cache line of the VIVT cache, at least a translation lookaside buffer (TLB) index corresponding to a TLB entry which comprises a virtual address to physical address translation for the cache line. Upon receiving an invalidate instruction, the method includes filtering the invalidate instruction at the TLB to determine if the invalidate instruction is likely to affect one or more cache lines in the VIVT cache. If the invalidate instruction is determined to be likely to affect one or more cache lines in the VIVT cache the TLB indices of the TLB entries which correspond to the invalidate instruction are determined, and only the cache lines of the VIVT cache which are associated with the TLB indices of the TLB entries which correspond to the invalidate instruction are selectively invalidated.

Another exemplary aspect is directed to an apparatus comprising a translation lookaside buffer (TLB) comprising TLB entries, wherein each TLB entry has an associated TLB index and comprises a virtual address to physical address translation. The apparatus also includes a virtually indexed virtually tagged (VIVT) cache comprising cache lines, wherein each cache line is tagged with at least the TLB index corresponding to the TLB entry which comprises the virtual address to physical address translation for the cache line. The apparatus further includes logic configured to filter an invalidate instruction received at the TLB to determine if the invalidate instruction is likely to affect one or more cache lines of the VIVT cache, and if the invalidate instruction is determined to be likely to affect one or more cache lines of the VIVT cache, determine the TLB indices of the TLB entries which correspond to the invalidate instruction, and selectively invalidate only the cache lines of the VIVT cache which are associated with the TLB indices of the TLB entries which correspond to the invalidate instruction.

Yet exemplary aspect is directed to an apparatus comprising a translation lookaside buffer (TLB) comprising TLB entries, wherein each TLB entry has an associated TLB index and comprises a virtual address to physical address translation and a virtually indexed virtually tagged (VIVT) cache comprising cache lines. The apparatus comprises means for tagging each cache line with at least the TLB index corresponding to the TLB entry which comprises the virtual address to physical address translation for the cache line, and means for filtering an invalidate instruction received at the TLB to determine if the invalidate instruction is likely to affect one or more cache lines in the VIVT cache. The apparatus also includes means for determining the TLB indices of the TLB entries which correspond to the invalidate instruction if the invalidate instruction is determined to be likely to affect one or more cache lines of the VIVT cache, and means for selectively invalidating only the one or more cache lines of the VIVT cache which are associated with the TLB indices of the TLB entries which correspond to the invalidate instruction if the invalidate instruction is determined to be likely to affect the one or more cache lines of the VIVT cache.

Another exemplary aspect is directed to a non-transitory computer readable storage medium comprising code, which, when executed by a processor, causes the processor to perform operations for managing a virtually indexed virtually tagged (VIVT) cache, the non-transitory computer readable storage medium comprising code for associating, with each cache line of the VIVT cache, at least a translation lookaside buffer (TLB) index corresponding to a TLB entry which comprises a virtual address to physical address translation for the cache line, code for filtering an invalidate instruction received at the TLB to determine if the invalidate instruction is likely to affect one or more cache lines in the VIVT cache, code for determining the TLB indices of the TLB entries which correspond to the invalidate instruction if the invalidate instruction is determined to be likely to affect one or more cache lines of the VIVT cache, and code for selectively invalidating only the one or more cache lines of the VIVT cache which are associated with the TLB indices of the TLB entries which correspond to the invalidate instruction if the invalidate instruction is determined to be likely to affect the one or more cache lines of the VIVT cache.

### BRIEF DESCRIPTION OF THE DRAWINGS

The accompanying drawings are presented to aid in the description of aspects of the invention and are provided solely for illustration of the aspects and not limitation thereof.

FIGS. 1A-C illustrate a conventional processing system and related aspects of performing invalidations.

FIGS. 2A-D illustrate an exemplary processing system and exemplary aspects of performing invalidations according to aspects of this disclosure.

FIG. 3 illustrates an exemplary operational flow of a method of cache management, according to exemplary aspects.

FIG. 4 depicts an exemplary computing device in which an aspect of the disclosure may be advantageously employed.

### DETAILED DESCRIPTION

Aspects of the invention are disclosed in the following description and related drawings directed to specific aspects of the invention. Alternate aspects may be devised without departing from the scope of the invention. Additionally, well-known elements of the invention will not be described in detail or will be omitted so as not to obscure the relevant details of the invention.

The word “exemplary” is used herein to mean “serving as an example, instance, or illustration.” Any aspect described herein as “exemplary” is not necessarily to be construed as preferred or advantageous over other aspects. Likewise, the term “aspects of the invention” does not require that all aspects of the invention include the discussed feature, advantage or mode of operation.

The terminology used herein is for the purpose of describing particular aspects only and is not intended to be limiting of aspects of the invention. As used herein, the singular forms “a”, “an” and “the” are intended to include the plural forms as well, unless the context clearly indicates otherwise. It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

Further, many aspects are described in terms of sequences of actions to be performed by, for example, elements of a computing device. It will be recognized that various actions described herein can be performed by specific circuits (e.g., application specific integrated circuits (ASICs)), by program instructions being executed by one or more processors, or by a combination of both. Additionally, these sequence of actions described herein can be considered to be embodied entirely within any form of computer readable storage medium having stored therein a corresponding set of computer instructions that upon execution would cause an associated processor to perform the functionality described herein. Thus, the various aspects of the invention may be embodied in a number of different forms, all of which have been contemplated to be within the scope of the claimed subject matter. In addition, for each of the aspects described herein, the corresponding form of any such aspects may be described herein as, for example, “logic configured to” perform the described action.

Exemplary aspects of this disclosure are directed to efficient and precise invalidation of virtually tagged memory structures such as a virtually indexed virtually tagged (VIVT) cache, e.g., pursuant to one or more translation lookaside buffer (TLB) invalidate operations. In exemplary aspects, one or more specific cache lines which are affected by an invalidate operation are efficiently determined. In one example, a cache line of a VIVT cache is tagged with a TLB index of a TLB entry which comprises a virtual to physical address translation for the cache line. When an invalidate operation is received (e.g., a TLB invalidate or a cache invalidate,), the invalidate is first filtered at the TLB to determine which one or more TLB indices are targeted by or correspond to the invalidate instruction, and only the cache lines of the VIVT cache corresponding to the one or more TLB indices which correspond to the invalidate instruction (as determined based on the TLB index tags associated with the cache lines) are precisely invalidated, without invalidating the entire VIVT cache.

Furthermore, in some aspects, rather than immediately invalidating the cache lines tagged with the TLB indices that correspond to an invalidate instruction upon receipt of the invalidate instruction, the TLB indices which correspond to the invalidate instructions are recorded for one or more successive invalidate instructions. For example, a TLB invalidate vector is maintained, which collects or records all the TLB indices for which invalidate instructions are pending, and the corresponding cache lines of the VIVT cache are invalidated at once, e.g., prior to a context synchronization. These and other exemplary features will now be discussed with reference to the figures below.

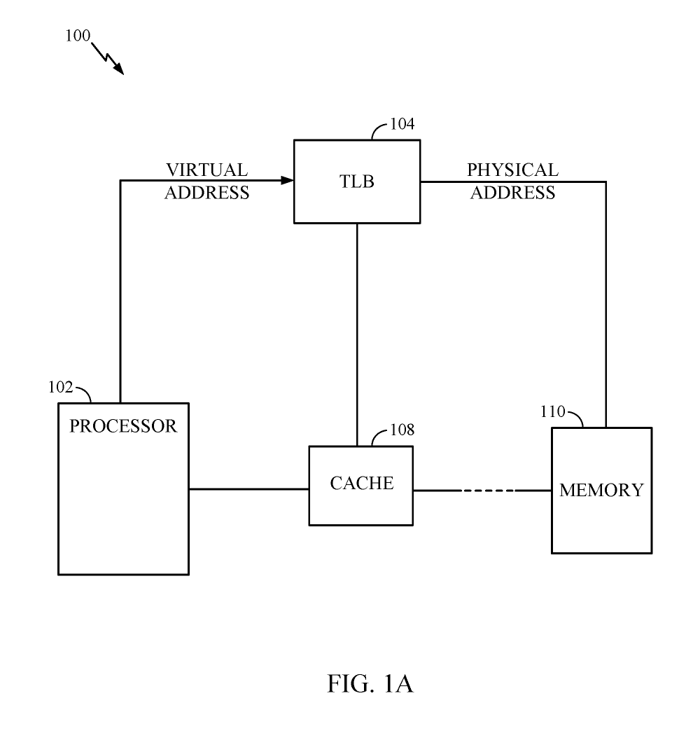

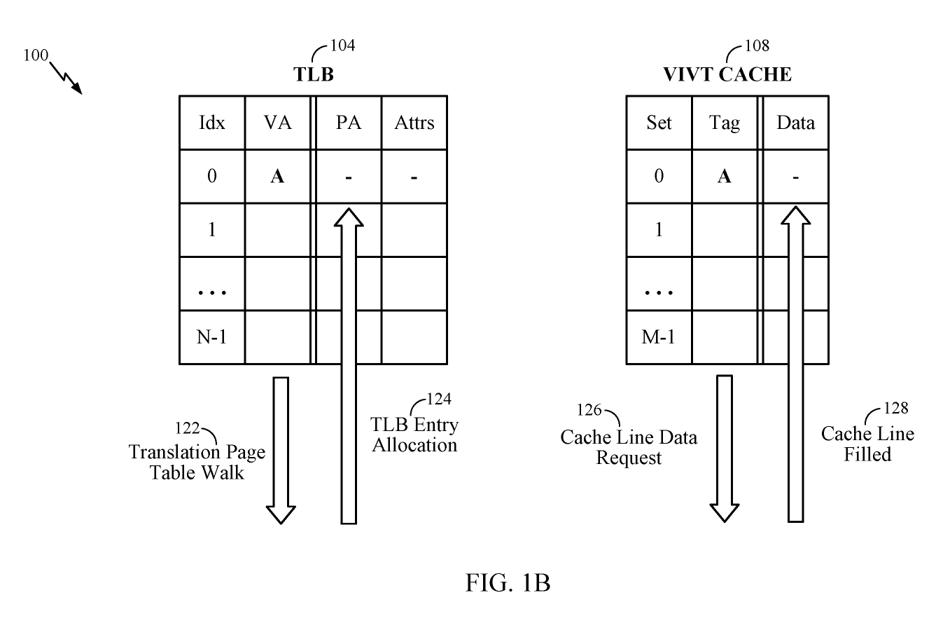

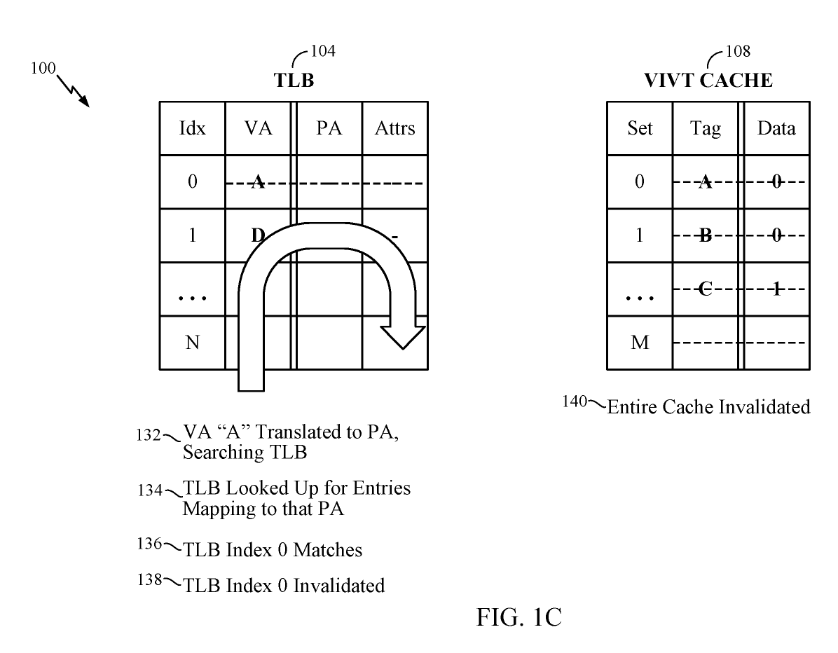

With reference now to FIG. 1A, aspects of a conventional processing system 100 are illustrated. Processing system 100 may comprise processor 102, which may be a central processing unit (CPU) or any processor core in general. Processor 102 may be configured to execute programs, software, etc., which may reference virtual addresses. Processor 102 may be coupled to one or more caches, of which cache 108, is representatively shown. Cache 108 may be an instruction cache, a data cache, or a combination thereof. In one example, cache 108 may be configured as a VIVT cache which may be accessed by processor 102 using virtual addresses. Cache 108, as well as one or more backing caches which may be present (but not explicitly shown) may be in communication with a main memory such as memory 110. Memory 110 may comprise physical memory in a physical address space and a memory management unit comprising TLB 104 may be used to obtain translations of virtual addresses (e.g., from processor 102) to physical addresses for ultimately accessing memory 110. Although memory 110 may be shared amongst one or more other processors or processing elements, these have not been illustrated, for the sake of simplicity.

Since cache 108 is a VIVT cache which is indexed and tagged with virtual addresses, in the conventional implementation of processing system 100 shown, processor 102 may access cache 108 using virtual addresses. But if there is a miss, in a conventional implementation which will be discussed with reference to FIG. 1B, a page table walk may be performed to obtain the virtual-to-physical address translation for the missing virtual address, access memory 110 (or a backing cache, if present), bring in the missing cache line and update cache 108 with the missing cache line and tag the cache line with the virtual address. However, as will be seen with reference to FIG. 1C, in the event of a translation invalidate, the entire cache 108 may need to be invalidated in the conventional implementation of processing system 100. Similarly, in the event of a cache invalidate, all sets of cache 108 that might map to the cache invalidate may need to be invalidated in the conventional implementation of processing system 100.

Accordingly, with reference to FIG. 1B, the conventional sequence of events corresponding to a cache access will now be discussed. In FIG. 1B, TLB 104 is shown with N entries corresponding to TLB indices 0 to N-1. Each of the N entries may be populated with a virtual address (VA) and a corresponding physical address (PA) translation. Additional attributes may also be associated with each of the N TLB entries. Cache 108 is shown as a set-associative VIVT cache, with M sets 0 to M-1, with only one representative cache line shown in each set, for the sake of simplicity, tagged with a virtual address (although each set may comprise more than one cache lines, as is known in the art for a set-associative cache implementation). The data stored in cache 108 may be accessed by indexing into one of the M sets using a portion of a virtual address and comparing tags of one or more cache lines within that set with another portion of the virtual address. If there is a match with one of the tags, then there is a hit; otherwise there is a miss.

Thus, considering an example where processor 102 issues a request to fetch a cache line from a virtual address (VA) denoted as “A” from cache 108 (which may be a VIVT instruction cache), if there is a hit, then the cache line at an address whose index corresponds to and whose tag matches virtual address A in cache 108 is returned to processor 102. If there is a miss in cache 108, on the other hand, TLB 104 is accessed to obtain the translation for the virtual address A to a corresponding physical address (PA), before backing storage locations of cache 108 are accessed using the physical address. However, there may be a miss in TLB 104 as well, which would lead to event 122 wherein a translation for virtual address A may be performed through a page table walk, for example. At event 124, the physical address for virtual address A is retrieved following the page table walk and an entry at index 0 of TLB 104 is populated with virtual address A and its corresponding physical address. Any other attributes (e.g., an application space identifier (ASID), processor identifier (PID), etc., as known in the art) may also be added to the TLB entry at index 0, but these are not particularly relevant to this disclosure. Subsequently, at event 126, the cache line may be retrieved from a backing storage location using the physical address translation for virtual address A, and at event 128, the cache line may be filled in cache 108 (e.g., in set 0 in the example shown), and tagged using the virtual address A (keeping in mind that a portion, e.g., a subset of bits, of the virtual address may be used in the tag, rather than the entire virtual address).

With reference now to FIG. 1C, a conventional sequence of events which take place when an invalidation operation is received at TLB 104, e.g., as an invalidate instruction, will be described. The invalidation operation may correspond to a translation invalidation based on a context change and issued by an operating system or processor 102, for example. The translation invalidation may be because the virtual address A no longer maps to the previously associated physical address. To determine which TLB entry is to be invalidated, in event 132, TLB 104 is accessed using the virtual address A to determine which TLB indices correspond to the translation invalidation (i.e., which TLB indices have virtual addresses which match the virtual address A specified by the translation invalidation). In one example, the translation invalidation may correspond to TLB index 0 of TLB 104 for TLB entry 0 comprising the matching virtual address A specified by the translation invalidation.

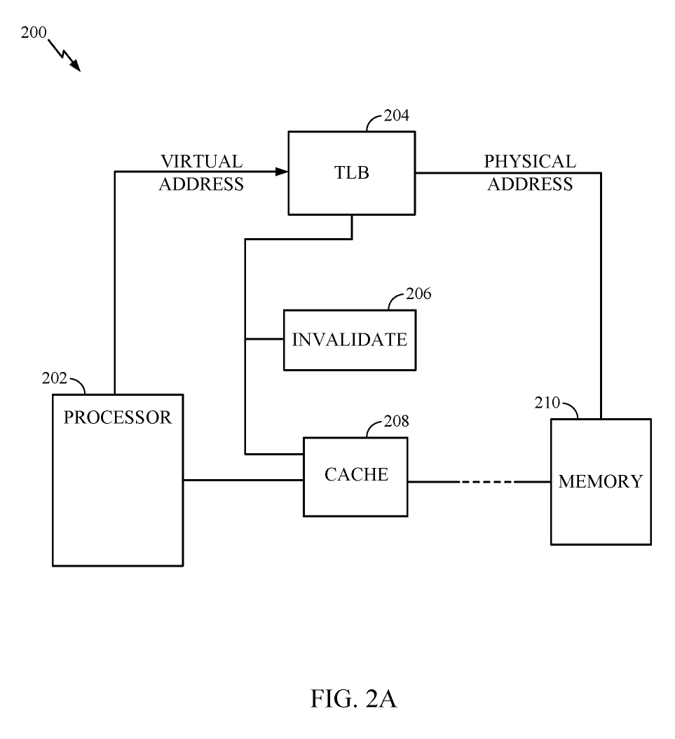

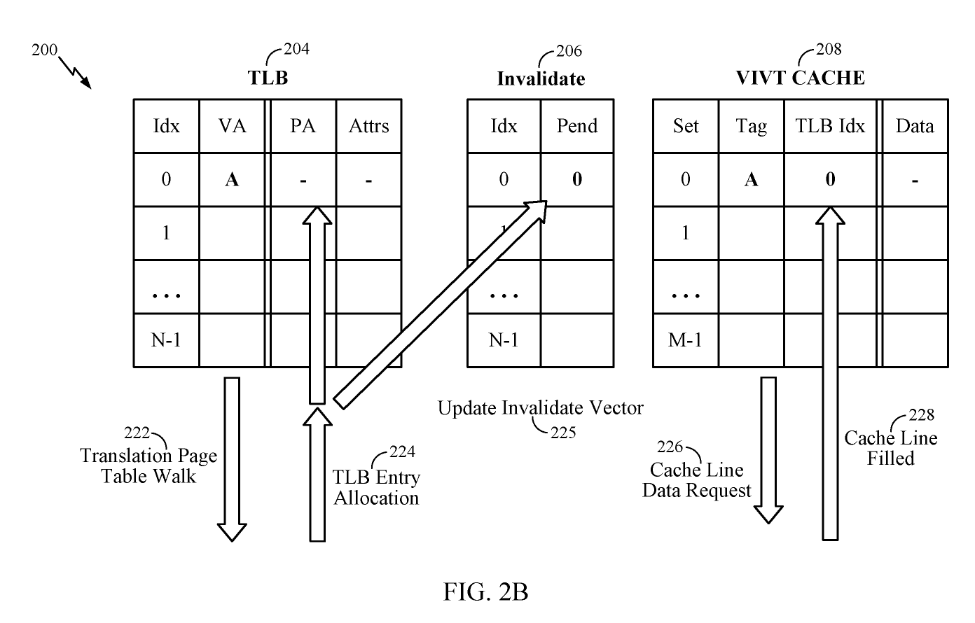

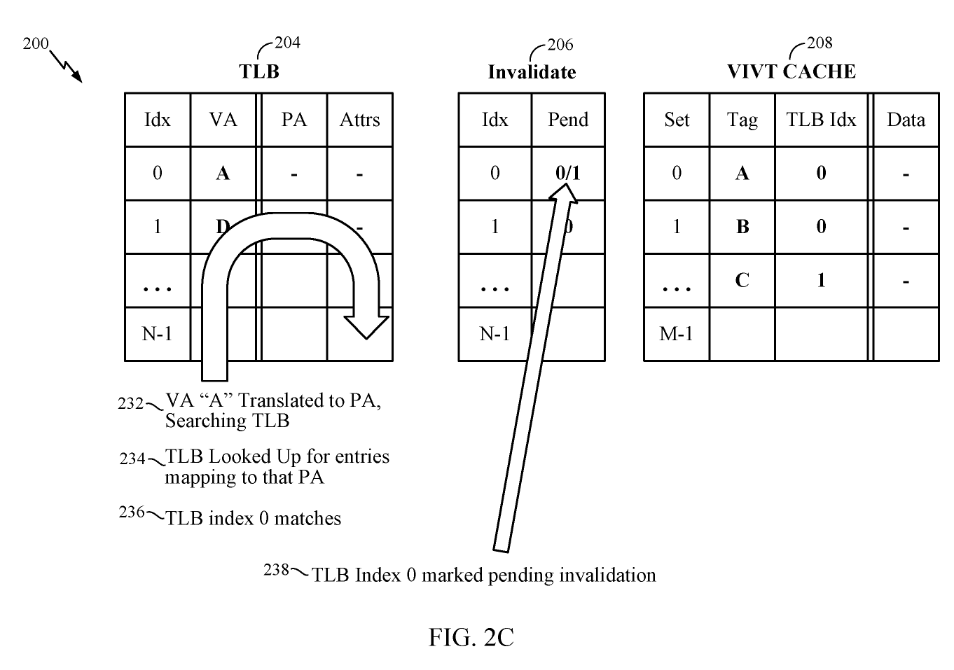

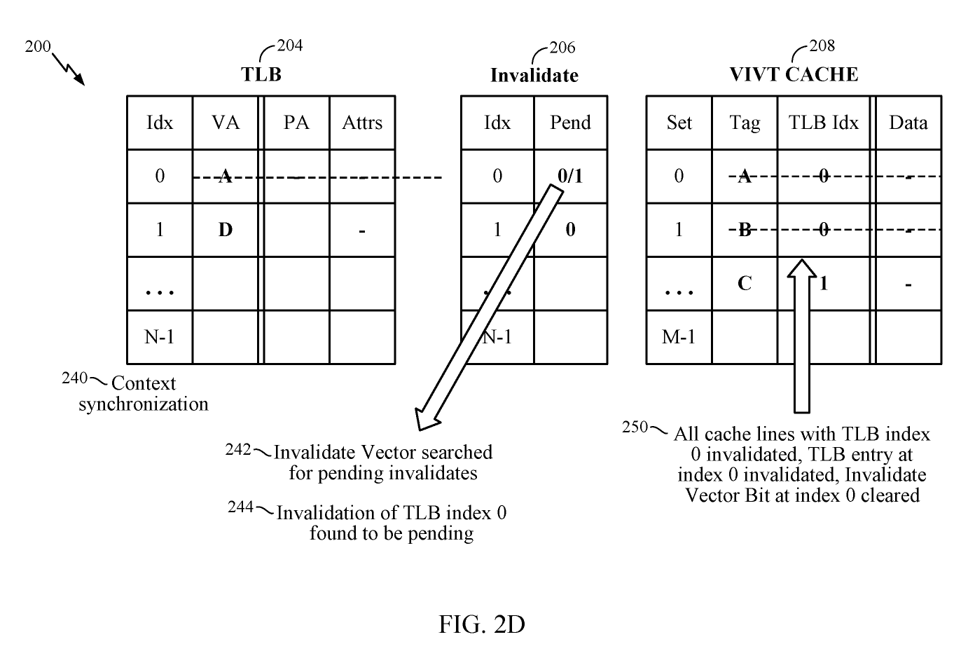

The effect of invalidating TLB index 0 of TLB 104 on cache 108 is denoted as event 140, wherein, the entire cache 108 is invalidated (all M cache lines of cache 108 are shown to be invalidated using strike-through notations, wherein the invalidation may be effected in practice by changing a valid bit associated with each cache line to indicate that the cache line is invalid, for example). The reason for invalidating all M cache lines, as a previously discussed, is because in the conventional implementations, there are no provisions for knowing which ones of the M cache lines are associated with the invalidated TLB entry at TLB index 0. As can be appreciated, invalidating the entire cache 108 can cause severe performance degradations. To avoid invaliding the entire cache 108 in this manner, exemplary techniques will be described with reference to FIGS. 2A-D.

In another case, the invalidation operation may be based on a cache invalidate operation using the virtual address A (e.g., an instruction cache invalidate by a virtual address to a point of unification, as known in the art). In this case, all instruction cache lines which have data for the physical address that the virtual address A translates to, are to be invalidated. In the conventional implementation, there are no provisions for knowing which of the cache lines that might be affected by the cache invalidate are actually associated with the invalidation and therefore all cache lines that may be or are likely to be affected by the cache invalidate are invalidated. As can be appreciated, invalidating cache lines in cache 108 that do not need to be invalidated can cause severe performance degradations. Exemplary techniques which will be described with reference to FIGS. 2A-D also avoid invaliding the cache lines in cache 108 in this manner

In order to more precisely invalidate a VIVT cache, exemplary features of additionally tagging cache lines of the VIVT cache with TLB indices, maintaining TLB indices pending invalidation in an invalidate vector, and precisely invalidating only specific cache lines based on their TLB index tags (and collectively invalidating a group of one or more cache lines of the VIVT cache based on the invalidate vector, e.g., at a context synchronization event), will be explained with reference to FIGS. 2A-C.

With reference now to FIG. 2A, an exemplary processing system 200 is illustrated. Processing system 200 may share some similarities with processing system 100 and so an exhaustive repetition of the similar features between processing systems 100 and 200 will be avoided. Accordingly, processor 202 may also be configured to execute programs, software, etc., which may reference virtual addresses, and be coupled to one or more caches, of which cache 208, is representatively shown. Cache 208 may also be an instruction cache, a data cache, or a combination thereof, and in one example, cache 208 may be configured as a VIVT cache which may be accessed by processor 202 using virtual addresses. Cache 208, as well as one or more backing caches which may be present (but has not been explicitly shown) may be in communication with a main memory such as memory 210, which may be shared amongst other processors, cores, etc. (not shown). Memory 210 may comprise physical memory in a physical address space and a memory management unit comprising TLB 204 may be used to obtain translations of virtual addresses (e.g., from processor 202) to physical addresses for ultimately accessing memory 210. Although memory 210 may be shared amongst one or more other processors or processing elements, these have not been illustrated, for the sake of simplicity.

Among other exemplary features of processing system 200, invalidate vector 206 is shown, which can be configured to comprise TLB indices for TLB entries which are pending invalidation. Further, in addition to cache 208 being configured as a VIVT cache which is indexed and tagged with virtual addresses, cache 208 may also be configured to additionally include for each cache line, a tag of the TLB index which comprises the translation for the virtual to physical address for the cache line. Processing system 200 may further include logic configured for precise invalidation of one or more cache lines of cache 208 based on the TLB index tags associated with the one or more cache lines. For example, pursuant to receiving an invalidate instruction, logic such as control logic (not specifically shown) associated with TLB 204 may be configured to filter the invalidate instruction at TLB 204 to determine if the invalidate instruction is likely to affect cache lines in cache 208. If the invalidate instruction is likely to affect cache lines in cache 208, the logic may be configured to determine the TLB indices of the TLB entries which correspond to the invalidate instruction. Further, logic (e.g., control logic for cache 208, not specifically shown) may be configured to selectively invalidate only the cache lines of the VIVT cache which are associated with the affected TLB indices. Further aspects of precise invalidation of cache lines of cache 208, will now be discussed with reference to FIGS. 2B-D.

With reference to FIG. 2B, TLB 204 is shown with N entries corresponding to TLB indices 0 to N-1. Each of the N entries may be populated with a virtual address (VA) and corresponding physical address (PA) translation. Additional attributes may also be associated with each of the N TLB entries. Invalidate vector 206 is shown to comprise the same number of N entries as TLB 204, with corresponding indices 0 to N-1 and invalidate vector 206 maintains an indication (e.g., one bit per entry) to show if a TLB entry at the corresponding index has a pending invalidation. Cache 208 is shown as a set-associative VIVT cache, with M sets 0 to M-1, with only one representative cache line shown in each set, for the sake of simplicity, tagged with a virtual address (although each set may comprise more than one cache lines, as is known in the art for a set-associative cache implementation). The data stored in cache 208 may be accessed by indexing into one of the M sets using a portion of a virtual address and comparing tags of one or more cache lines within that set with another portion of the virtual address. If there is a match with one of the tags, then there is a hit; otherwise there is a miss.

Thus, considering an example where processor 202 issues a request to fetch a cache line from a virtual address (VA) denoted as “A” from cache 208 (which may be a VIVT instruction cache), if there is a hit, then the cache line at an address whose index corresponds to and tag matches virtual address A in cache 208 is returned to processor 202. If there is a miss in cache 208, on the other hand, TLB 204 is accessed to obtain the translation for the virtual address A to a corresponding physical address (PA), before backing storage locations of cache 208 are accessed using the physical address. However, there may be a miss in TLB 204 as well, which would lead to event 222, wherein a translation for virtual address A may be performed through a page table walk, for example. At event 224, the physical address for virtual address A is retrieved following the page table walk and an entry at index 0 of TLB 104 is populated with virtual address A and its corresponding physical address. Any other attributes (e.g., an application space identifier (ASID), processor identifier (PID), etc., as known in the art) may also be added to the TLB entry at index 0, but these are not particularly relevant to this disclosure. Additionally, event 225 also takes place simultaneously or in conjunction with event 224, wherein, in event 225, invalidate vector 206 is updated to indicate that the TLB entry at index 0 does not have an associated pending invalidate operation (e.g., pending bit is “0” for index 0).

Subsequently, at event 226, the cache line may be retrieved from a backing storage location using the physical address, and at event 228, the cache line may be filled in cache 208 (e.g., in set 0 in the example shown), and tagged using the virtual address A (keeping in mind that a portion of the virtual address may be used in the tag, rather than the entire virtual address). Additionally, the cache line is also tagged with the TLB index 0 corresponding to the TLB entry which was allocated at event 224 in TLB 204 with the translation of the virtual to physical address for the cache line.

In an exemplary aspect, TLB 204 is inclusive of all the cache lines in the VIVT cache, cache 208, which means that all cache lines in cache 208 will be tagged with an associated TLB index when the cache lines are filled in cache 208, and all cache lines in cache 208 with a given TLB index tag will be invalidated if the entry in TLB 204 corresponding to that TLB index is replaced (e.g. due to eviction caused by the reallocation of the TLB entry). Precise invalidation of cache lines is thus possible for several types of invalidation operations which may be filtered at TLB 204.

For example, in a first type of invalidation operation which may be a translation invalidation, a TLB invalidate operation may be used to remove a stale mapping of a virtual address, e.g., virtual address A, to a physical address in TLB 204. Correspondingly, the translation invalidation may require invalidating the cache lines of cache 208 which are associated with the virtual address A specified in the TLB invalidate operation, since virtual address A may no longer map to the physical address associated with the data in the VIVT cache. In the exemplary VIVT cache tagged with the TLB index, this invalidation may be performed by searching TLB 204 (which is inclusive of the VIVT cache 208) using the virtual address A. The TLB entries which match the virtual address A are invalidated in TLB 204 and the TLB indices of these entries invalidated in TLB 204 are used to precisely invalidate cache lines which have matching TLB indices. The VIVT cache 208 may be configured to support the functionality of a search and invalidate using the TLB indices (and as will be described in more detail, the actual invalidation may occur during the next context synchronization operation).

In a second type of invalidation operation pertaining to a cache invalidation, invalidation of cache 208 may be specified by a virtual address A (e.g., an instruction cache invalidate by virtual address to point of unification, “ICIVAU” as known in the art). In this case, all cache lines of cache 208 which have data for the physical address that the virtual address A translates to are to be invalidated. For a VIVT cache, since different cache lines with different virtual addresses may all map to the same physical address, precise invalidation of only those cache lines with virtual addresses which map to the physical address corresponding to virtual address A may be pursued in exemplary aspects, to avoid over-invalidating the VIVT cache. In this regard, processor 202, which may initiate the invalidation, for example, may first translates the virtual address A to a corresponding physical address (e.g., based on a page table walk). The physical address may then be broadcast and used to invalidate corresponding cache lines in all instruction caches in processing system 200, including cache 208. The invalidation, in exemplary aspects, may involve performing a reverse lookup of TLB 204 (which, once again, is inclusive of the VIVT cache 204) using the physical address, to determine which TLB entries have the same physical address which was specified in the invalidate instruction. Correspondingly, the cache lines which are tagged with TLB indices of the matching TLB entries may then be precisely invalidated.

With reference now to FIG. 2C, an exemplary sequence of events which take place when an invalidation operation such as one of the above two cases is received at TLB 204 will be described. The invalidation operation may be based on a context change and sent by an operating system or processor 202, for example. The invalidation operation may be because the virtual address A no longer maps to the previously associated physical address. In the first case wherein the invalidation operation is a translation invalidation or TLB invalidate operation which specifies virtual address A, TLB 204 may be searched with the virtual address A and the TLB index 0 of TLB 204 may be found which matches virtual address A. In the second case, wherein the invalidation operation may be a cache invalidate operation which provides the physical address to be invalidated, the physical address is used to perform a search of TLB 204 in a reverse manner and all TLB entries which have a physical address translation which match the physical address provided by the cache invalidate operation are obtained in event 234. In the example shown, only the TLB entry at TLB index 0 has a matching entry for the physical address, as determined at event 236. In both cases, once the TLB indices are obtained, at event 238, invalidate vector 206 may be updated to change (from “0” to “1”) the indication corresponding to TLB index 0 that an invalidate operation is now pending at TLB index 0.

Corresponding invalidations of cache 208 may be filtered by TLB 204 in the above-described aspects of FIG. 2C. For example, invalidates to TLB 204 (both local invalidates from processor 202, as well as invalidates to maintain coherence with any other processors which may be present and received at TLB 204 via snoop operations or other coherence mechanisms) may be gathered in invalidate vector 206, as they are received (keeping in mind that some invalidate operations such as a cache flash invalidate operation which is directed to invalidate the entire cache 208 need not be filtered by TLB 204, since their intended effect is to invalidate the entire cache 208 anyway). The TLB invalidates may be gathered in invalidate vector 206 until an event such as a context synchronization is received, rather than applying the TLB invalidates to invalidate cache lines of cache 208 immediately upon each TLB invalidate operation being recorded in invalidate vector 206.

A context synchronization, as known in the art, is a point in the sequence of instructions being executed, e.g., by processor 202, which mandates that any change to architectural resources (e.g., registers) before this point is to be observed by all instructions after this point. A context synchronizing event can be inserted into the sequence of instructions being executed in one or more ways, including, for example, by software, through the use of a context synchronizing instruction (e.g. an instruction barrier); by hardware, before or after a hardware-enforced context synchronizing event as defined by an applicable instruction set architecture (ISA) (e.g. before an exception or after execution of a hardware-synchronized register access); or by hardware for an internal operation, which may be invisible to software. As such, the invalidate operations to cache lines of cache 208 need not be applied (e.g., due to translation changes) until a context synchronization event forces the changes by the translation invalidate to be observed by subsequent instructions after the context synchronization event.

Although the context synchronization event is one example described herein, the gathered invalidates in invalidate vector 206 may also be applied based on events other than a context synchronization. For example, a software hint may be provided to apply the gathered invalidates. In another example, a miss in either TLB 204 or in cache 208 may be used as a trigger to apply the gathered invalidates.

Furthermore, the pending invalidates gathered in invalidate vector 206 need not be applied simultaneously or at once but may be applied piecemeal, e.g., one or more of the gathered invalidates may be read out from invalidate vector 206 at separate times and corresponding cache lines may be invalidated. In some cases, a count may be maintained of the number of invalidates gathered in invalidate vector 206 and if this count exceeds a pre-specified threshold, then the invalidates may be applied when the count exceeds the threshold, rather than upon the occurrence of an event such as a context synchronization, a software hint, a miss in either TLB 204 or cache 208, etc.

Accordingly, with reference to FIG. 2D, exemplary sequences which follow a context synchronization event 240 are shown. More than one TLB entry (e.g., at TLB indices 0 and 1) may have been populated before context synchronization event 240 occurs, wherein corresponding entries in invalidate vector 206 may have been updated based on whether invalidates are pending to the corresponding TLB entries (a pending invalidate is shown for the entry of invalidate vector 206 corresponding to TLB index 0, but not for TLB index 1). At event 242 invalidate vector 206 is searched to determine all the pending invalidates. At event 244, a pending invalidate operation is recognized for TLB index 0 in invalidate vector 206.

Subsequently, at event 250, cache 208 is searched using the TLB index 0 to determine all cache lines whose TLB index tag match the TLB index 0. Only those cache lines which are tagged with TLB index 0 are selectively invalidated, while the remaining cache lines whose tags do not match the TLB index 0 are not invalidated. Simultaneously, or in conjunction with invalidating these cache lines, the indication in invalidate vector 206 for pending invalidation of TLB index 0 is also cleared.

In this manner, only cache lines of the exemplary VIVT cache which are affected by one or more invalidations are selectively invalidated, thus avoiding invalidation of the entire cache upon each translation invalidation or instruction cache invalidation. Furthermore, inclusivity is maintained between the exemplary TLB and the VIVT cache, which enables effective filtering of invalidate operations at the TLB (e.g., if all cache lines of the VIVT cache are tagged with corresponding TLB indices, then it is possible to filter out invalidate operations which do not affect the VIVT cache).

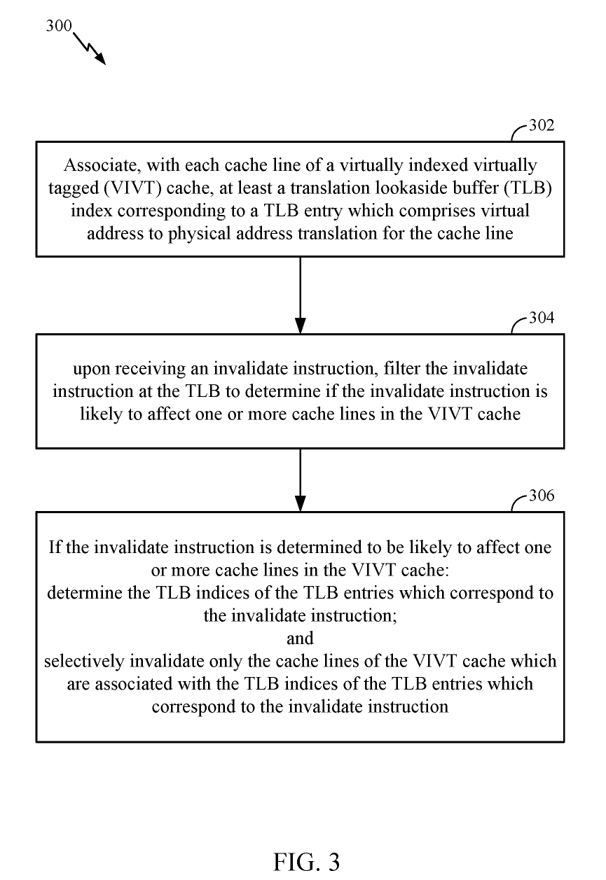

It will be appreciated that aspects include various methods for performing the processes, functions and/or algorithms disclosed herein. For example, as illustrated in FIG. 3, an aspect can include a method (300) of managing a cache (e.g., VIVT cache 208).

Block 302 comprises associating, with each cache line of a virtually indexed virtually tagged (VIVT) cache, at least a translation lookaside buffer (TLB) index (e.g., of TLB 204) corresponding to a TLB entry which comprises virtual address to physical address translation for the cache line (e.g., at the time of filling the cache line at event 228, FIG. 2B).

In Block 304, upon receiving an invalidate instruction, the invalidate instruction is filtered at the TLB to determine if the invalidate instruction is likely to affect one or more cache lines in the VIVT cache. For example, determining if the invalidate instruction is likely to affect one or more cache lines in the VIVT cache can involve, if the invalidate instruction is a translation invalidate instruction, determining if the a virtual address specified by the translation invalidate instruction matches at least one of the virtual addresses for which translations are included in TLB 204. If the invalidate instruction is a cache invalidate instruction, determining if the invalidate instruction is likely to affect one or more cache lines in the VIVT cache can involve determining, based on a reverse search of TLB 204, if a physical address specified by the cache invalidate instruction matches a translated physical address in at least one entry of TLB 204. Further, in some aspects, one or more invalidates are gathered in an invalidate vector such as invalidate vector 206. Thus, by maintaining inclusivity between TLB 204 and cache 208, the invalidate instruction can be filtered at TLB 204 to determine if the invalidate instruction is likely to affect one or more cache lines or if the invalidate instruction does not affect cache lines of cache 208. Furthermore the filtering at TLB 204 may also filter out cache flash invalidates).

In Block 306, if the invalidate instruction is determined to be likely to affect one or more cache lines in the VIVT cache the TLB indices of the TLB entries which correspond to the invalidate instruction may be determined. Further, only the cache lines of the VIVT cache which are associated with the TLB indices of the TLB entries which correspond to the invalidate instruction may be selectively invalidated. For example, only the cache lines associated with TLB index 0 are selectively invalidated at event 250 as discussed above with regard to FIG. 2D.

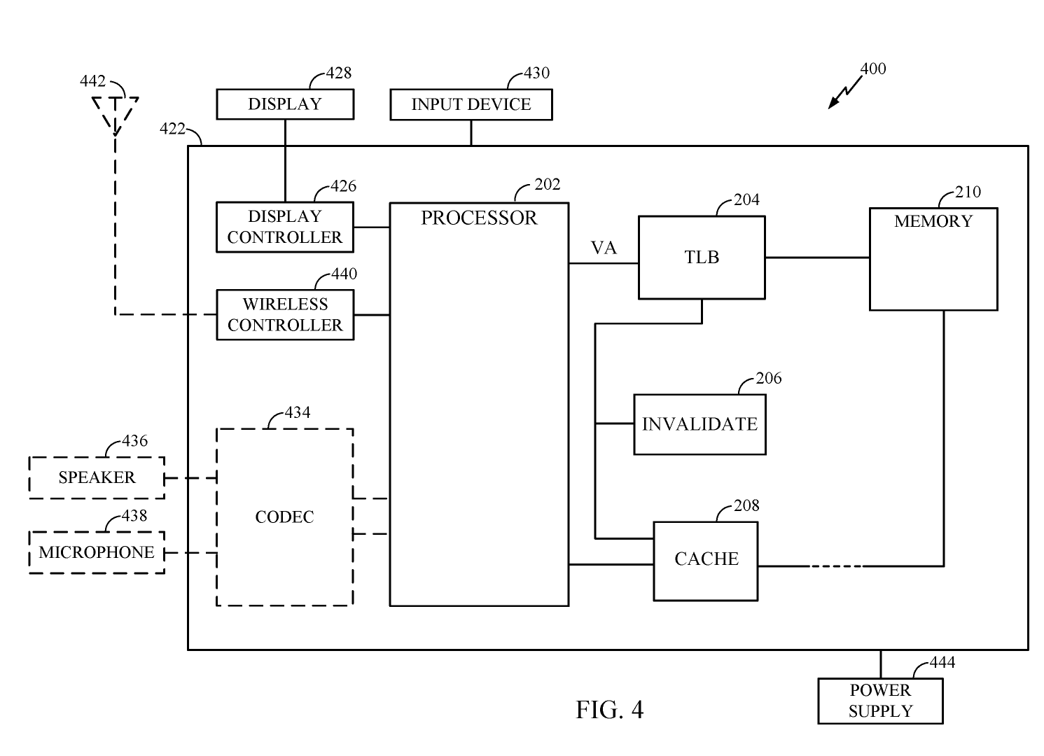

An example apparatus in which exemplary aspects of this disclosure may be utilized, will now be discussed in relation to FIG. 4. FIG. 4 shows a block diagram of computing device 400. Computing device 400 may correspond to an exemplary implementation of a processing system configured to perform method 300 of FIG. 3. In the depiction of FIG. 4, computing device 400 is shown to include processor 202, TLB 204, invalidate vector 206, cache 208, and memory 210 as discussed with reference to FIGS. 2A-D, but it will be understood that other memory configurations known in the art may also be supported by computing device 400.

FIG. 4 also shows display controller 426 that is coupled to processor 202 and to display 428. In some cases, computing device 400 may be used for wireless communication and FIG. 4 also shows optional blocks in dashed lines, such as coder/decoder (CODEC) 434 (e.g., an audio and/or voice CODEC) coupled to processor 202 and speaker 436 and microphone 438 can be coupled to CODEC 434; and wireless antenna 442 coupled to wireless controller 440 which is coupled to processor 202. Where one or more of these optional blocks are present, in a particular aspect, processor 202, display controller 426, memory 210, and wireless controller 440 are included in a system-in-package or system-on-chip device 422.

Accordingly, a particular aspect, input device 430 and power supply 444 are coupled to the system-on-chip device 422. Moreover, in a particular aspect, as illustrated in FIG. 4, where one or more optional blocks are present, display 428, input device 430, speaker 436, microphone 438, wireless antenna 442, and power supply 444 are external to the system-on-chip device 422. However, each of display 428, input device 430, speaker 436, microphone 438, wireless antenna 442, and power supply 444 can be coupled to a component of the system-on-chip device 422, such as an interface or a controller.

It should be noted that although FIG. 4 generally depicts a computing device, processor 202 and memory 210, may also be integrated into a set top box, a music player, a video player, an entertainment unit, a navigation device, a personal digital assistant (PDA), a fixed location data unit, a server, a computer, a laptop, a tablet, a communications device, a mobile phone, or other similar devices.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The methods, sequences and/or algorithms described in connection with the aspects disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor.

Accordingly, an aspect of the invention can include a computer readable media embodying a method for cache management, including precise invalidation of cache lines of a VIVT cache. Accordingly, the invention is not limited to illustrated examples and any means for performing the functionality described herein are included in aspects of the invention.

While the foregoing disclosure shows illustrative aspects of the invention, it should be noted that various changes and modifications could be made herein without departing from the scope of the invention as defined by the appended claims. The functions, steps and/or actions of the method claims in accordance with the aspects of the invention described herein need not be performed in any particular order. Furthermore, although elements of the invention may be described or claimed in the singular, the plural is contemplated unless limitation to the singular is explicitly stated.

What is claimed is:

1. A method of managing a virtually indexed virtually tagged (VIVT) cache, the method comprising:
associating, with each cache line of the VIVT cache, at least a translation lookaside buffer (TLB) index corresponding to a TLB entry which comprises a virtual address to physical address translation for the cache line;
upon receiving an invalidate instruction, filtering the invalidate instruction at the TLB to determine if the invalidate instruction is likely to affect one or more cache lines in the VIVT cache; and
if the invalidate instruction is determined to be likely to affect one or more cache lines in the VIVT cache:
determining the TLB indices of the TLB entries which correspond to the invalidate instruction; and
selectively invalidating only the cache lines of the VIVT cache which are associated with the TLB indices of the TLB entries which correspond to the invalidate instruction.

2. The method of claim 1, further comprising gathering TLB indices affected by one or more invalidate instructions in an invalidate vector, and selectively invalidating the cache lines of the VIVT cache which are associated with the affected TLB indices gathered in the invalidate vector upon a context synchronization event.

3. The method of claim 2, comprising maintaining indications of whether or not an invalidation is pending for the TLB indices in the invalidate vector.

4. The method of claim 1, comprising associating the TLB index with a cache line of the VIVT cache pursuant to a miss in the VIVT cache for the cache line and while filling the cache line in the VIVT cache at an index based on the virtual address for the cache line.

5. The method of claim 4, further comprising tagging the cache line with at least a portion of the virtual address for the cache line.

6. The method of claim 4, comprising maintaining inclusivity among the TLB and the VIVT cache.

7. The method of claim 6, comprising determining the TLB indices of the TLB entries which correspond to the invalidate instruction using a virtual address specified by the invalidate instruction, wherein the invalidate instruction is a translation invalidate instruction for the TLB.

8. The method of claim 6, comprising determining the TLB indices of the TLB entries which correspond to the invalidate instruction using a physical address corresponding to a virtual address specified by the invalidate instruction, wherein the invalidate instruction is a cache invalidate instruction for the VIVT cache.

9. The method of claim 1 comprising filtering out flash invalidates of the entire VIVT cache at the TLB.

10. The method of claim 1, wherein the VIVT cache is an instruction cache.

11. The method of claim 1, wherein the VIVT cache is visible to software as a physically indexed physically tagged (PIPT) cache.

12. An apparatus comprising:
a translation lookaside buffer (TLB) comprising TLB entries, wherein each TLB entry has an associated TLB index and comprises a virtual address to physical address translation;
a virtually indexed virtually tagged (VIVT) cache comprising cache lines, wherein each cache line is tagged with at least the TLB index corresponding to the TLB entry which comprises the virtual address to physical address translation for the cache line; and
logic configured to:
filter an invalidate instruction received at the TLB to determine if the invalidate instruction is likely to affect one or more cache lines of the VIVT cache; and
if the invalidate instruction is determined to be likely to affect one or more cache lines of the VIVT cache, determine the TLB indices of the TLB entries which correspond to the invalidate instruction, and selectively invalidate only the cache lines of the VIVT cache which are associated with the TLB indices of the TLB entries which correspond to the invalidate instruction.

13. The apparatus of claim 12, further comprising an invalidate vector configured to gather TLB indices affected by one or more invalidate instructions, and logic configured to selectively invalidate the cache lines of the VIVT cache which are associated with the affected TLB indices gathered in the invalidate vector upon a context synchronization event.

14. The apparatus of claim 13, wherein the invalidate vector is configured to maintain indications of whether or not an invalidation is pending for the TLB indices in the invalidate vector.

15. The apparatus of claim 12, wherein each cache line is also tagged with at least a portion of the virtual address for the cache line.

16. The apparatus of claim 12, wherein the TLB entries are inclusive of the cache lines of the VIVT cache.

17. The apparatus of claim 12, further comprising logic configured to determine the TLB indices of TLB entries which correspond to the invalidate instruction based on a virtual address specified by the invalidate instruction, wherein the invalidate instruction is a translation invalidate instruction for the TLB.

18. The apparatus of claim 12, comprising logic configured to determine the TLB indices of the TLB entries which correspond to the invalidate instruction based on a physical address corresponding to a virtual address specified by the invalidate instruction, wherein the invalidate instruction is a cache invalidate instruction for the VIVT cache.

19. The apparatus of claim 12 comprising logic configured filter out flash invalidates of the entire VIVT cache, at the TLB.

20. The apparatus of claim 12, wherein the VIVT cache is an instruction cache.

21. The apparatus of claim 12, wherein the VIVT cache is visible to software as a physically indexed physically tagged (PIPT) cache.

22. The apparatus of claim 12, integrated into a device selected from the group consisting of a set top box, a music player, a video player, an entertainment unit, a navigation device, a personal digital assistant (PDA), a fixed location data unit, a server, a computer, a laptop, a tablet, a communications device, and a mobile phone.

23. An apparatus comprising:
a translation lookaside buffer (TLB) comprising TLB entries, wherein each TLB entry has an associated TLB index and comprises a virtual address to physical address translation;
a virtually indexed virtually tagged (VIVT) cache comprising cache lines;
means for tagging each cache line with at least the TLB index corresponding to the TLB entry which comprises the virtual address to physical address translation for the cache line; and
means for filtering an invalidate instruction received at the TLB to determine if the invalidate instruction is likely to affect one or more cache lines in the VIVT cache;
means for determining the TLB indices of the TLB entries which correspond to the invalidate instruction if the invalidate instruction is determined to be likely to affect one or more cache lines of the VIVT cache; and
means for selectively invalidating only the one or more cache lines of the VIVT cache which are associated with the TLB indices of the TLB entries which correspond to the invalidate instruction if the invalidate instruction is determined to be likely to affect the one or more cache lines of the VIVT cache.

24. A non-transitory computer readable storage medium comprising code, which, when executed by a processor, causes the processor to perform operations for managing a virtually indexed virtually tagged (VIVT) cache, the non-transitory computer readable storage medium comprising:
code for associating, with each cache line of the VIVT cache, at least a translation lookaside buffer (TLB) index corresponding to a TLB entry which comprises a virtual address to physical address translation for the cache line;
code for filtering an invalidate instruction received at the TLB to determine if the invalidate instruction is likely to affect one or more cache lines in the VIVT cache;
code for determining the TLB indices of the TLB entries which correspond to the invalidate instruction if the invalidate instruction is determined to be likely to affect one or more cache lines of the VIVT cache; and
code for selectively invalidating only the one or more cache lines of the VIVT cache which are associated with the TLB indices of the TLB entries which correspond to the invalidate instruction if the invalidate instruction is determined to be likely to affect the one or more cache lines of the VIVT cache.

25. The non-transitory computer readable storage medium of claim 24, further comprising code for gathering TLB indices affected by one or more invalidate instructions in an invalidate vector, and code for selectively invalidating the cache lines of the VIVT cache which are associated with the affected TLB indices gathered in the invalidate vector upon a context synchronization event.

26. The non-transitory computer readable storage medium of claim 25, comprising code for maintaining indications of whether or not an invalidation is pending for the TLB indices in the invalidate vector.

27. The non-transitory computer readable storage medium of claim 24, comprising code for associating the TLB index with a cache line of the VIVT cache pursuant to a miss in the VIVT cache for the cache line and while filling the cache line in the VIVT cache at an index based on the virtual address for the cache line.

28. The non-transitory computer readable storage medium of claim 27, further comprising code for tagging the cache line with at least a portion of the virtual address for the cache line.

29. The non-transitory computer readable storage medium of claim 27, comprising code for maintaining inclusivity among the TLB and the VIVT cache.

30. The non-transitory computer readable storage medium of claim 24 comprising code for filtering out flash invalidates of the entire VIVT cache at the TLB.
